(19) United States
(12) Patent Application Publication
(10) Pub. No.: US 2013/0163661 A1
(43) Pub. Date: Jun. 27, 2013

(54) VIDEO ENCODING USING EXAMPLE - BASED DATA PRUNING

(71) Applicants: Dong-Qing Zhang, Bridgewater, NJ (US); Sitaram Bhagavathy, Palo Alto, CA (US)

(72) Inventors: Dong-Qing Zhang, Bridgewater, NJ (US); Sitaram Bhagavathy, Palo Alto, CA (US)

(73) Assignee: THOMSON LICENSING, Issy de Moulineaux (FR)

(21) Appl. No.: 13/821,257

(22) PCT Filed: Sep. 9, 2011
(86) PCT No.: PCT/US11/50917

§ 371 Date: Mar. 7, 2013

Related U.S. Application Data
(60) Provisional application No. 61/403,108, filed on Sep. 10, 2010.

(51) Int. Cl. H04N 7/26

(52) U.S. Cl. CPC H04N 19/00133
USPC 375/240.02

(57) ABSTRACT

Methods and apparatus are provided for encoding video signals using example-based data pruning for improved video compression efficiency. An apparatus for encoding a picture in a video sequence includes a patch library creator for creating a first patch library from an original version of the picture and a second patch library from a reconstructed version of the picture. Each of the first patch library and the second patch library includes a plurality of high resolution replacement patches for replacing one or more pruned blocks during a recovery of a pruned version of the picture. The apparatus also includes a pruner for generating the pruned version of the picture from the first patch library, and a metadata generator for generating metadata from the second patch library. The metadata is for recovering the pruned version of the picture. The apparatus further includes an encoder for encoding the pruned version of the picture and the metadata.

This application claims the benefit of U.S. Provisional Application Ser. No. 61/403,108 entitled EXAMPLE-BASED DATA PRUNING FOR IMPROVING VIDEO COMPRESSION EFFICIENCY filed on Sep. 10, 2010 (Technicolor Docket No. PU100193).

This application is related to the following co-pending, commonly-owned, patent applications:
(1) International (PCT) Patent Application Serial No. PCT/US11/000107 entitled A SAMPLING-BASED SUPER-RESOLUTION APPROACH FOR EFFICIENT VIDEO COMPRESSION filed on Jan. 20, 2011 (Technicolor Docket No. PU100004);
(2) International (PCT) Patent Application Serial No. PCT/US11/000117 entitled DATA PRUNING FOR VIDEO COMPRESSION USING EXAMPLE-BASED SUPER-RESOLUTION filed on Jan. 21, 2011 (Technicolor Docket No. PU100014);
(3) International (PCT) Patent Application Serial No. ______ entitled METHODS AND APPARATUS FOR ENCODING VIDEO SIGNALS USING MOTION COMPENSATED EXAMPLE-BASED SUPER-RESOLUTION FOR VIDEO COMPRESSION filed on Sep. ______, 2011 (Technicolor Docket No. PU100190);
(4) International (PCT) Patent Application Serial No. ______ entitled METHODS AND APPARATUS FOR DECODING VIDEO SIGNALS USING MOTION COMPENSATED EXAMPLE-BASED SUPER-RESOLUTION FOR VIDEO COMPRESSION filed on Sep. ______, 2011 (Technicolor Docket No. PU100266);
(5) International (PCT) Patent Application Serial No. ______ entitled METHODS AND APPARATUS FOR DECODING VIDEO SIGNALS USING EXAMPLE-BASED DATA PRUNING FOR IMPROVED VIDEO COMPRESSION EFFICIENCY filed on Sep. ______, 2011 (Technicolor Docket No. PU100267);
(6) International (PCT) Patent Application Serial No. ______ entitled METHODS AND APPARATUS FOR ENCODING VIDEO SIGNALS FOR BLOCK-BASED MIXED-RESOLUTION DATA PRUNING filed on Sep. ______, 2011 (Technicolor Docket No. PU100194);
(7) International (PCT) Patent Application Serial No. ______ entitled METHODS AND APPARATUS FOR DECODING VIDEO SIGNALS FOR BLOCK-BASED MIXED-RESOLUTION DATA PRUNING filed on Sep. ______, 2011 (Technicolor Docket No. PU100268);
(8) International (PCT) Patent Application Serial No. ______ entitled METHODS AND APPARATUS FOR EFFICIENT REFERENCE DATA ENCODING FOR VIDEO COMPRESSION BY IMAGE CONTENT BASED SEARCH AND RANKING filed on Sep. ______, 2011 (Technicolor Docket No. PU100195);
(9) International (PCT) Patent Application Serial No. ______ entitled METHOD AND APPARATUS FOR EFFICIENT REFERENCE DATA DECODING FOR VIDEO COMPRESSION BY IMAGE CONTENT BASED SEARCH AND RANKING filed on Sep. ______, 2011 (Technicolor Docket No. PU110106);
(10) International (PCT) Patent Application Serial No. ______ entitled METHOD AND APPARATUS FOR ENCODING VIDEO SIGNALS FOR EXAMPLE-BASED DATA PRUNING USING INTRA-FRAME PATCH SIMILARITY filed on Sep. ______, 2011 (Technicolor Docket No. PU100196);
(11) International (PCT) Patent Application Serial No. ______ entitled METHOD AND APPARATUS FOR DECODING VIDEO SIGNALS WITH EXAMPLE-BASED DATA PRUNING USING INTRA-FRAME PATCH SIMILARITY filed on Sep. ______, 2011 (Technicolor Docket No. PU100269); and
(12) International (PCT) Patent Application Serial No. ______ entitled PRUNING DECISION OPTIMIZATION IN EXAMPLE-BASED DATA PRUNING COMPRESSION filed on Sep. ______, 2011 (Technicolor Docket No. PU10197).

The present principles relate generally to video encoding and decoding and, more particularly, to methods and apparatus for example-based data pruning for improving video compression efficiency.

Data pruning is a video preprocessing technology to achieve better video coding efficiency by removing a portion of input video data before the video data is encoded. The removed video data is recovered at the decoder side by inferring the removed video data from the decoded data. There have been some prior efforts relating to the use of data pruning to increase compression efficiency. For example, in a first approach (described in A. Dumitras and B. G. Haskell, “A Texture Replacement Method at the Encoder for Bit Rate Reduction of Compressed Video,” IEEE Transactions on Circuits and Systems for Video Technology, Vol. 13, No. 2, February 2003, pp. 163-175) and a second approach (described in A. Dumitras and B. G. Haskell, “An encoder-decoder texture replacement method with application to content-based movie coding,” IEEE Transactions on Circuits and Systems for Video Technology, vol. 14, issue 6, June 2004, pp. 825-840), a texture replacement based method is used to remove texture regions at the encoder side, and re-synthesize the texture regions at the decoder side. Compression efficiency is gained because only synthesis parameters are sent to the decoder, which have smaller amount of data than the regular transformation coefficients.

In a third approach (described in C. Zhu, X. Sun, F. Wu, and H. Li, “Video Coding with Spatio-Temporal Texture Synthesis,” IEEE International Conference on Multimedia and Expo (ICME), 2007) and a fourth approach (described in C. Zhu, X. Sun, F. Wu, and H. Li, “Video coding with spatio-temporal texture synthesis and edge-based inpainting,” IEEE International Conference on Multimedia and Expo (ICME), 2008), spatio-temporal texture synthesis and edge-based inpainting are used to remove some of the regions at the encoder side, and the removed content is recovered at the decoder side, with the help of metadata, such as region masks. However, the third and fourth approaches need to modify the encoder and decoder so that the encoder/decoder can selectively perform encoding/decoding for some of the regions using the region masks. Therefore, it is not exactly an out-of-loop approach because the encoder and decoder need to be modified in order to be able to perform the third and fourth approaches. In a fifth approach (described in Dung T. Vo, Joel Sole, Peng Yin, Cristina Gomila and Truong Q. Nguyen, “Data Pruning-Based Compression using High Order Edge-Directed Interpolation,” IEEE Conference on Acoustics, Speech and Signal Processing, Taiwan, R.O.C., 2009), a line removal based method is proposed to rescale a video to a smaller size by selectively removing some of the horizontal or vertical lines in the video with a least-square minimization framework. The fifth approach is an out-of-loop approach, and does not require modification of the encoder/decoder. However, completely removing certain horizontal and vertical lines may result in a loss of information or details for some videos.

Furthermore, some preliminary researches on data pruning for video compression have been conducted. For example, in a sixth approach—described in Sitaram Bhagavathy, Dong-Qing Zhang and Mithun Jacob, “A Data Pruning Approach for Video Compression Using Motion-Guided Down-sampling and Super-resolution,” submitted to ICIP 2010 on Feb. 8, 2010, filed as a co-pending commonly-owned U.S. Provisional Patent Application (Ser. No. 61/297,320) on Jan. 22, 2010 (Technicolor docket number PU100004)—a data pruning scheme using sampling-based super-resolution is presented. The full resolution frame is sampled into several smaller-sized frames, therefore reducing the spatial size of the original video. At the decoder side, the high-resolution frame is re-synthesized from the downsampled frames with the help of metadata received from the encoder side. In a seventh approach—described in Dong-Qing Zhang, Sitaram Bhagavathy, and Joan Llach, “Data pruning for video compression using example-based super-resolution,” filed as a co-pending commonly-owned U.S. Provisional Patent Application (Ser. No. 61/336,516) on Jan. 22, 2010 (Technicolor docket number PU100014)—an example-based super-resolution based method for data pruning is presented. A representative patch library is trained from the original video. Afterwards, the video is downsized to a smaller size. The downsized video and the patch library are sent to the decoder side. The recovery process at the decoder side super-resolves the downsized video by example-based super-resolution using the patch library. However, as there is substantial redundancy between the patch library and downsized frames, it has been discovered that a substantive level of compression gain may not easily be obtained with the seventh approach.

This application discloses method and apparatus for example-based data pruning to improve video compression efficiency.

According to an aspect of the present principles, there is provided an apparatus for encoding a picture in a video sequence. The apparatus includes a patch library creator for creating a first patch library from an original version of the picture and a second patch library from a reconstructed version of the picture. Each of the first patch library and the second patch library includes a plurality of high resolution replacement patches for replacing one or more pruned blocks during a recovery of a pruned version of the picture. The apparatus also includes a pruner for generating the pruned version of the picture from the first patch library, and a metadata generator for generating metadata from the second patch library. The metadata is for recovering the pruned version of the picture. The apparatus further includes an encoder for encoding the pruned version of the picture and the metadata.

According to another aspect of the present principles, there is provided a method for encoding a picture in a video sequence. The method includes creating a first patch library from an original version of the picture and a second patch library from a reconstructed version of the picture. Each of the first patch library and the second patch library includes a plurality of high resolution replacement patches for replacing one or more pruned blocks during a recovery of a pruned version of the picture. The method also includes generating the pruned version of the picture from the first patch library, and generating metadata from the second patch library. The metadata is for recovering the pruned version of the picture. The method further includes encoding the pruned version of the picture and the metadata.

According to still another aspect of the present principles, there is provided an apparatus for recovering a pruned version of a picture in a video sequence. The apparatus includes a divider for dividing the pruned version of the picture into a plurality of non-overlapping blocks, and a metadata decoder for decoding metadata for use in recovering the pruned version of the picture. The apparatus also includes a patch library creator for creating a patch library from a reconstructed version of the picture. The patch library includes a plurality of high-resolution replacement patches for replacing the one or more pruned blocks during a recovery of the pruned version of the picture. The apparatus further includes a search and replacement device for performing a searching process using the metadata to find a corresponding patch for a respective one of the one or more pruned blocks from among the plurality of non-overlapping blocks and replace the respective one of the one or more pruned blocks with the corresponding patch.

According to a further aspect of the present principles, there is provided a method for recovering a pruned version of a picture in a video sequence. The method includes dividing the pruned version of the picture into a plurality of non-overlapping blocks, and decoding metadata for use in recovering the pruned version of the picture. The method also includes creating a patch library from a reconstructed version of the picture. The patch library includes a plurality of high-resolution replacement patches for replacing the one or more pruned blocks during a recovery of the pruned version of the picture. The method further includes performing a searching process using the metadata to find a corresponding patch for a respective one of the one or more pruned blocks from among the plurality of non-overlapping blocks and replace the respective one of the one or more pruned blocks with the corresponding patch.

According to a still further aspect of the present principles, there is provided an apparatus for encoding a picture in a video sequence. The apparatus includes means for creating a first patch library from an original version of the picture and a second patch library from a reconstructed version of the picture. Each of the first patch library and the second patch library includes a plurality of high resolution replacement patches for replacing one or more pruned blocks during a recovery of a pruned version of the picture. The apparatus also includes means for generating the pruned version of the picture from the first patch library, and means for generating metadata from the second patch library, the metadata for recovering the pruned version of the picture. The apparatus further includes means for encoding the pruned version of the picture and the metadata.

According to an additional aspect of the present principles, there is provided an apparatus for recovering a pruned version of a picture in a video sequence. The apparatus includes means for dividing the pruned version of the picture into a plurality of non-overlapping blocks, and means for decoding metadata for use in recovering the pruned version of the picture. The apparatus also includes means for creating a patch library from a reconstructed version of the picture. The patch library includes a plurality of high-resolution replacement patches for replacing the one or more pruned blocks during a recovery of the pruned version of the picture. The apparatus further includes means for performing a searching process using the metadata to find a corresponding patch for a respective one of the one or more pruned blocks from among the plurality of non-overlapping blocks and replace the respective one of the one or more pruned blocks with the corresponding patch.

These and other aspects, features and advantages of the present principles will become apparent from the following detailed description of exemplary embodiments, which is to be read in connection with the accompanying drawings.

The present principles may be better understood in accordance with the following exemplary figures, in which:

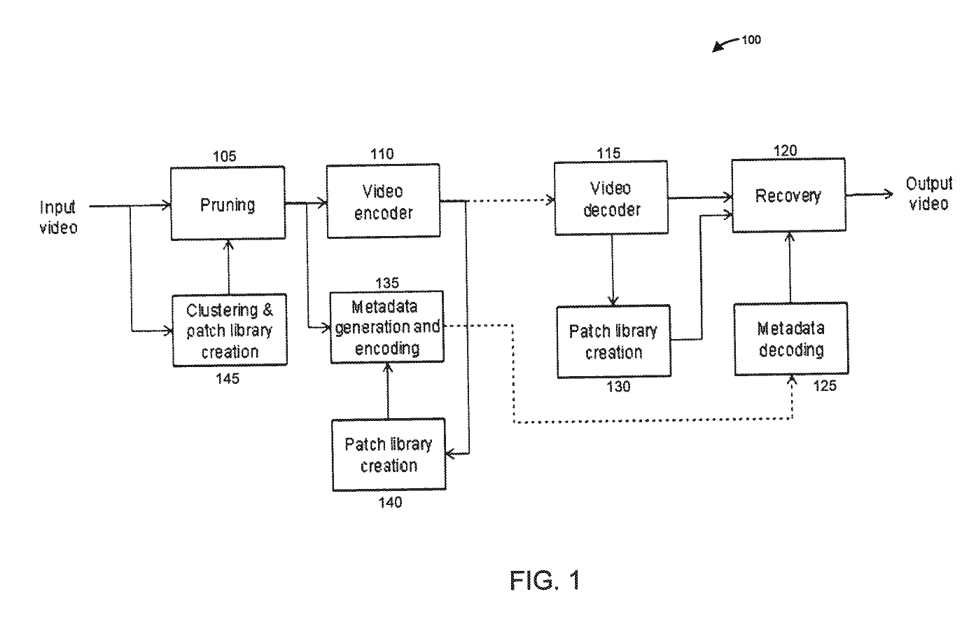

FIG. 1 is a block diagram showing an exemplary example-based data pruning system using patch similarity, in accordance with an embodiment of the present principles;

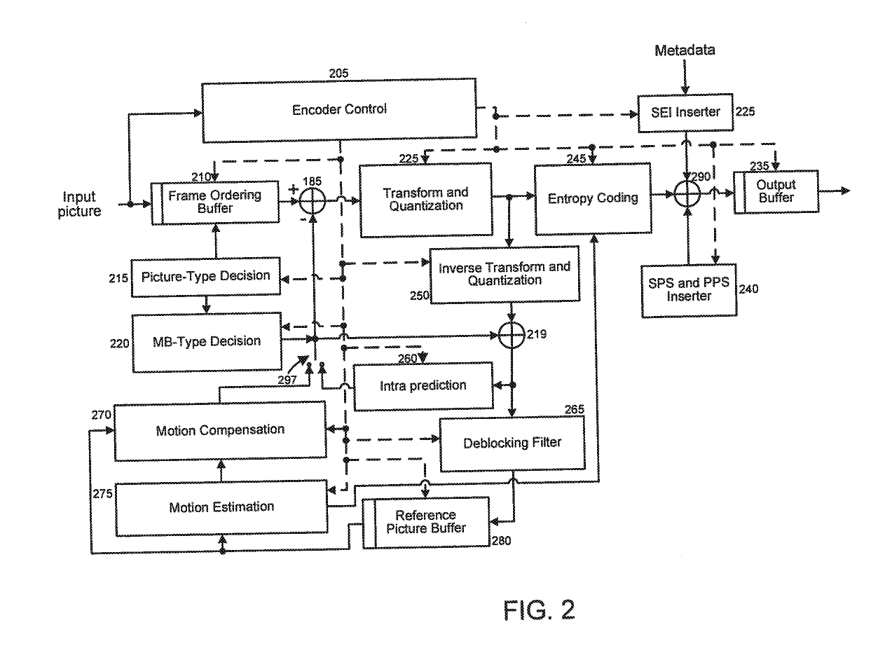

FIG. 2 is a block diagram showing an exemplary video encoder to which the present principles may be applied, in accordance with an embodiment of the present principles;

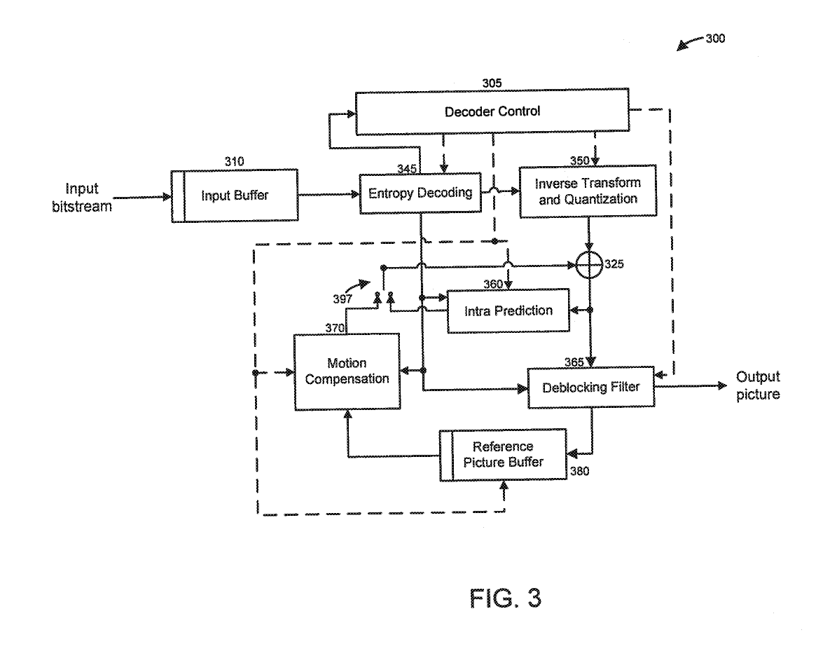

FIG. 3 is a block diagram showing an exemplary video decoder to which the present principles may be applied, in accordance with an embodiment of the present principles;

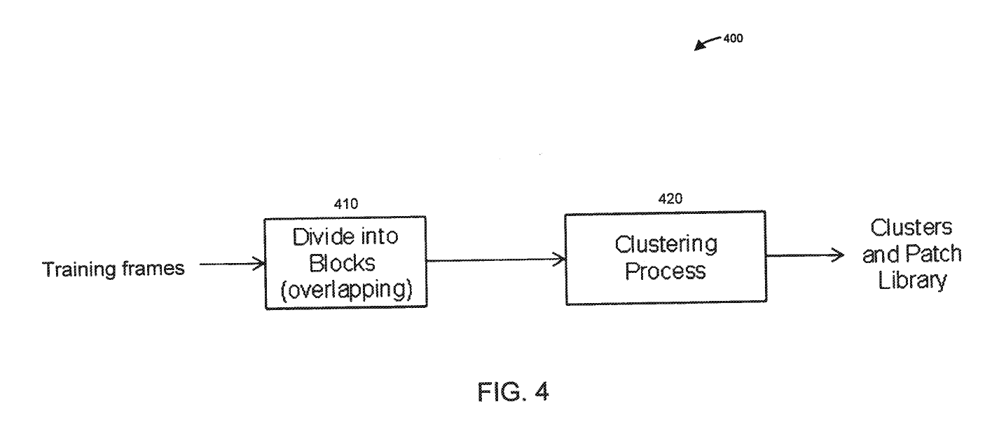

FIG. 4 is a block diagram showing an exemplary first portion for performing encoder side processing in an example-based data pruning system, in accordance with an embodiment of the present principles;

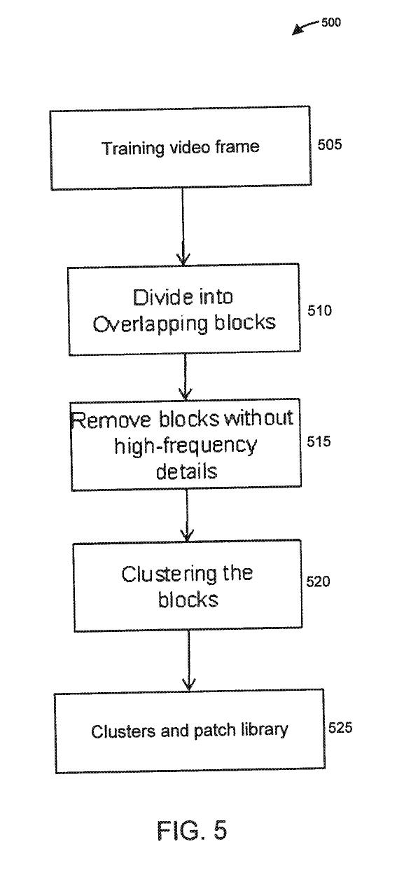

FIG. 5 is a flow diagram showing an exemplary method for clustering and patch library creation, in accordance with an embodiment of the present principles;

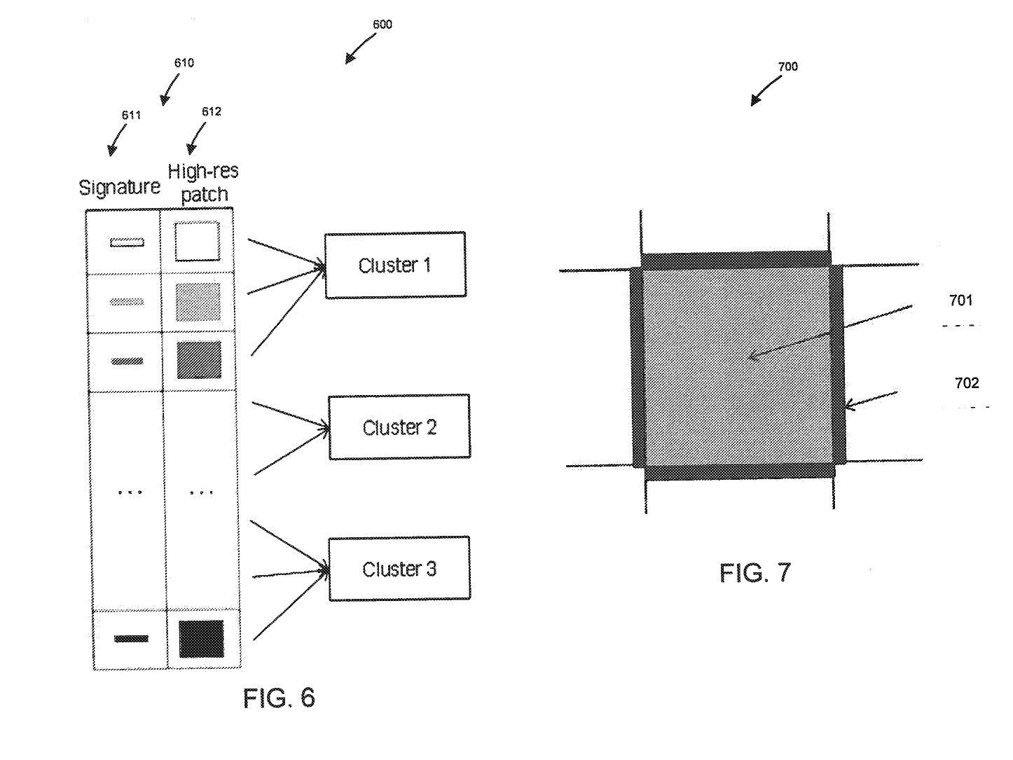

FIG. 6 is a diagram showing an exemplary patch library and corresponding clusters, in accordance with an embodiment of the present principles;

FIG. 7 is a diagram showing an exemplary signature vector, in accordance with an embodiment of the present principles;

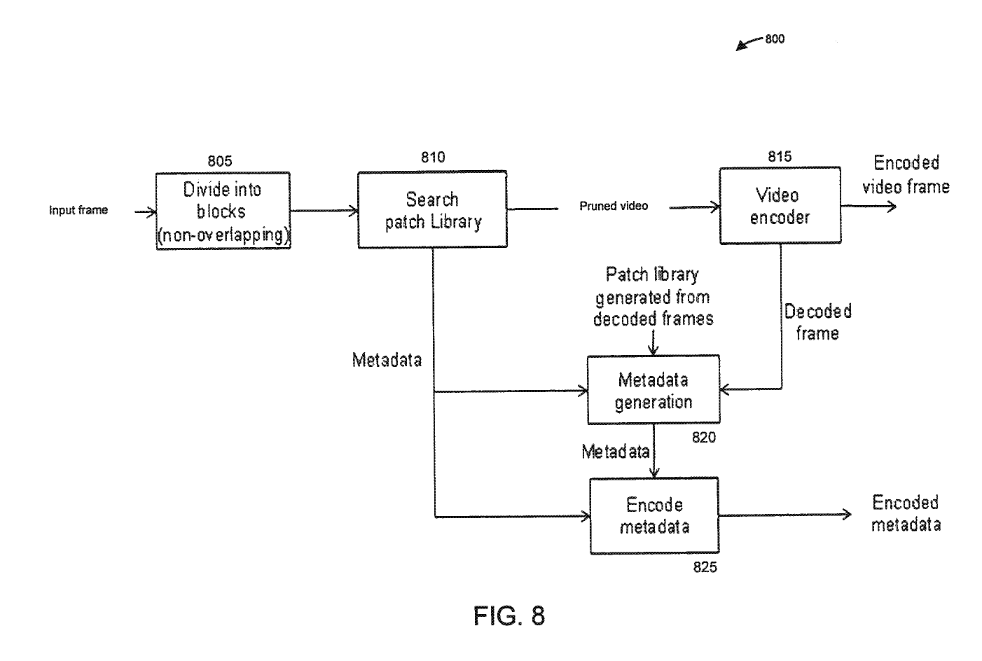

FIG. 8 is a block diagram showing an exemplary second portion for performing encoder side processing in an example-based data pruning system using patch similarity, in accordance with an embodiment of the present principles;

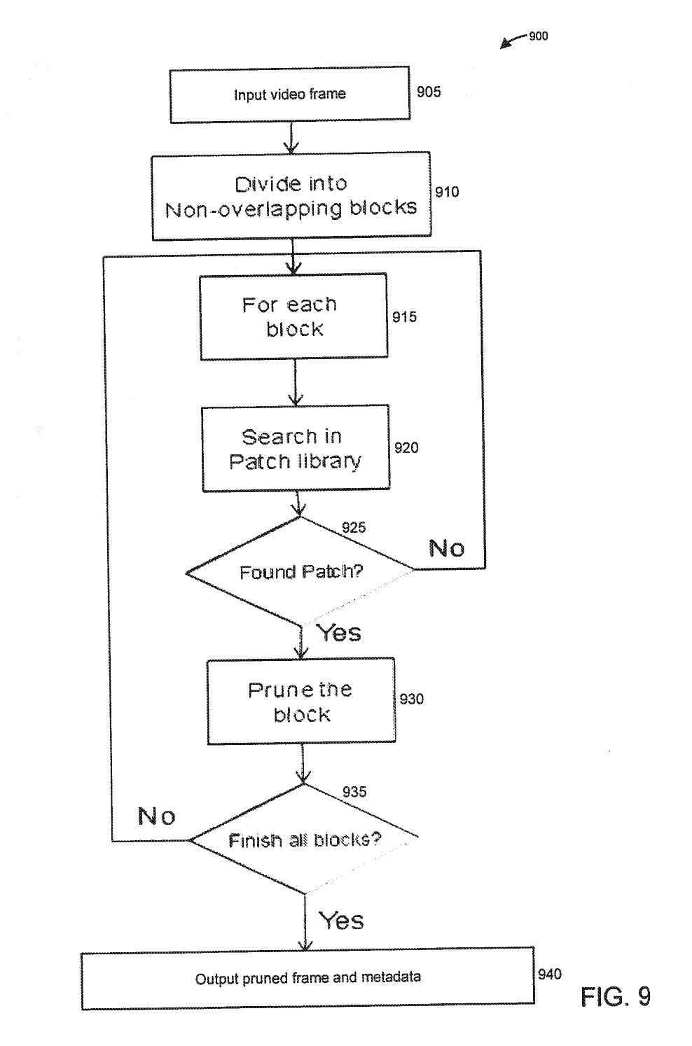

FIG. 9 is a flow diagram showing an exemplary method for video frame pruning, in accordance with an embodiment of the present principles;

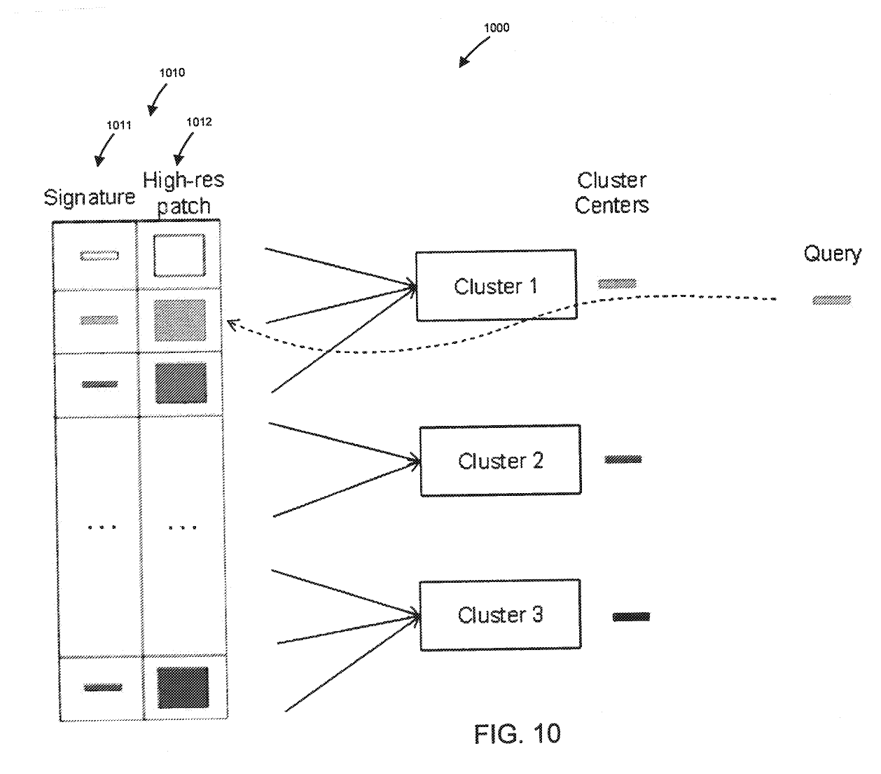

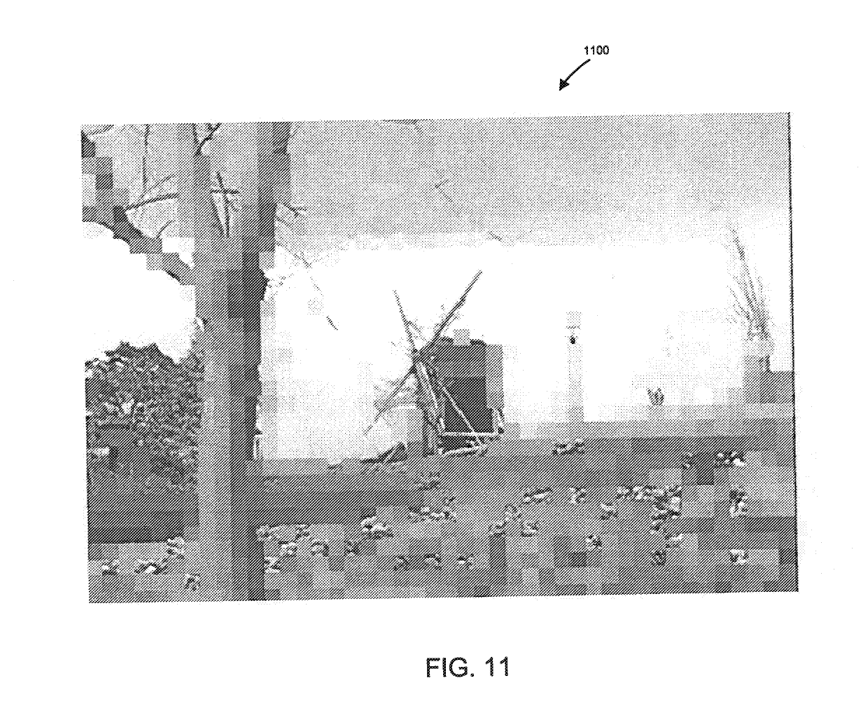

FIG. 10 is a diagram showing a patch search process, in accordance with an embodiment of the present principles;

FIG. 11 is an image showing an exemplary mixed-resolution frame, in accordance with an embodiment of the present principles;

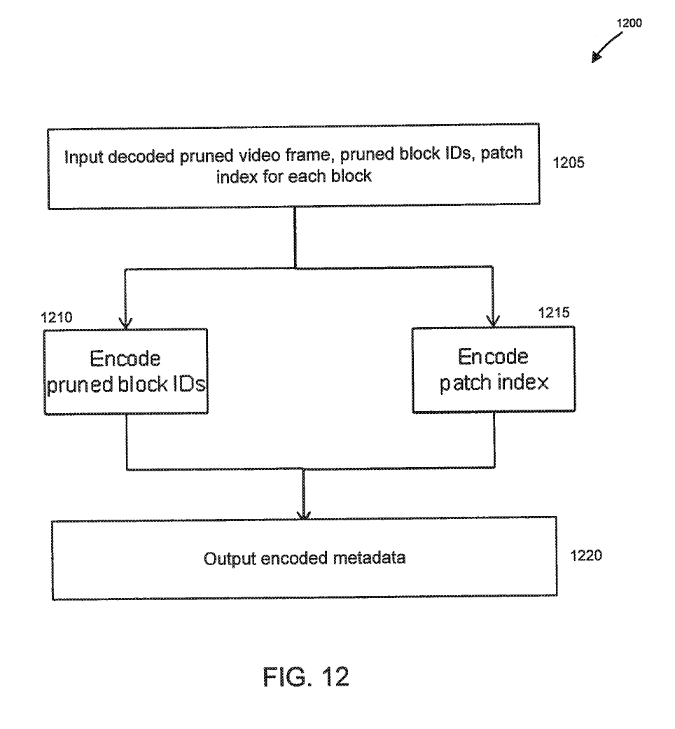

FIG. 12 is a flow diagram showing an exemplary method for encoding metadata, in accordance with an embodiment of the present principles;

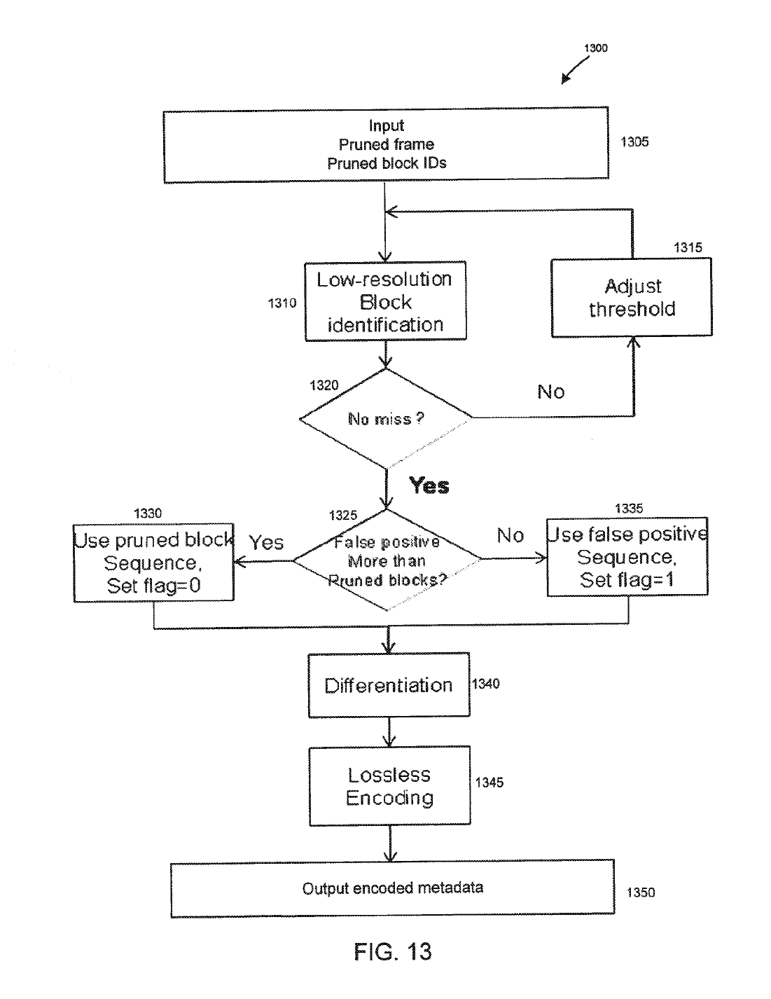

FIG. 13 is a flow diagram showing an exemplary method for encoding pruned block IDs, in accordance with an embodiment of the present principles;

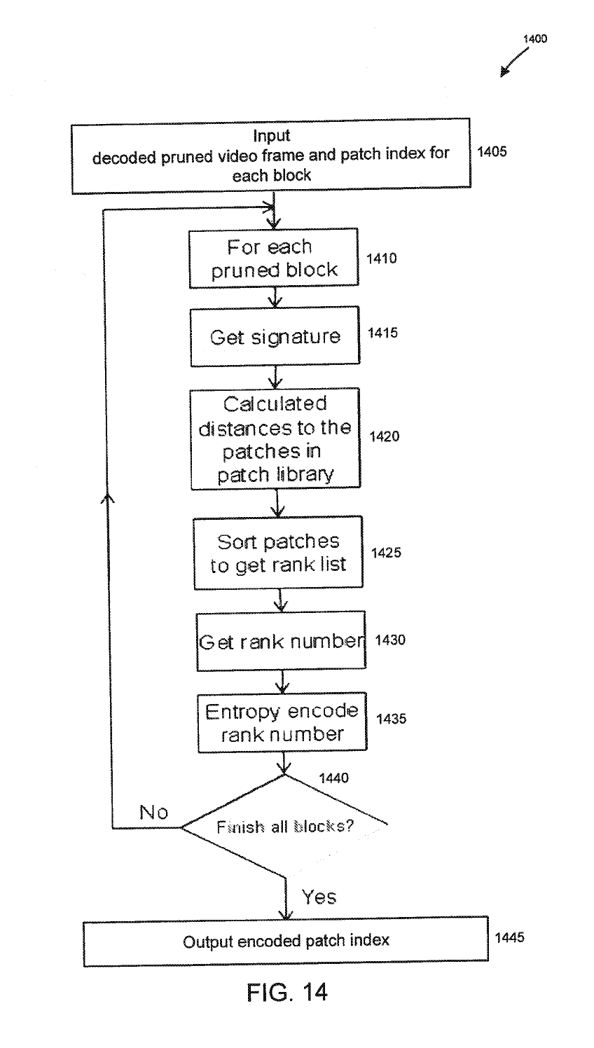

FIG. 14 is a flow diagram showing an exemplary method for encoding a patch index, in accordance with an embodiment of the present principles;

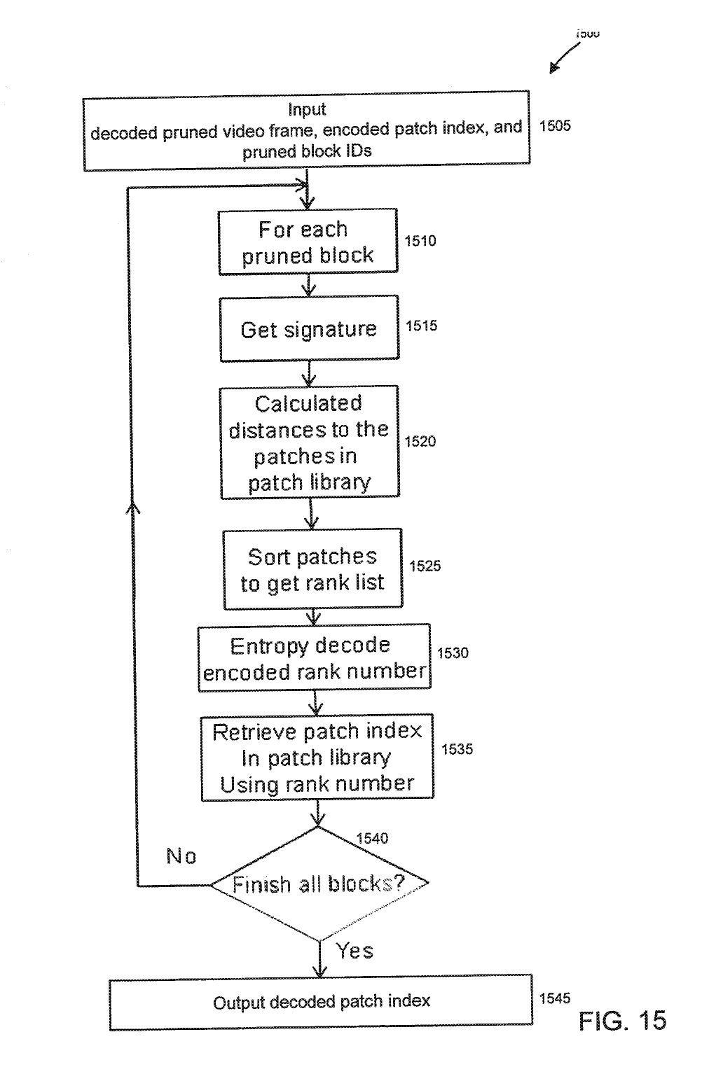

FIG. 15 is a flow diagram showing an exemplary method for decoding a patch index, in accordance with an embodiment of the present principles;

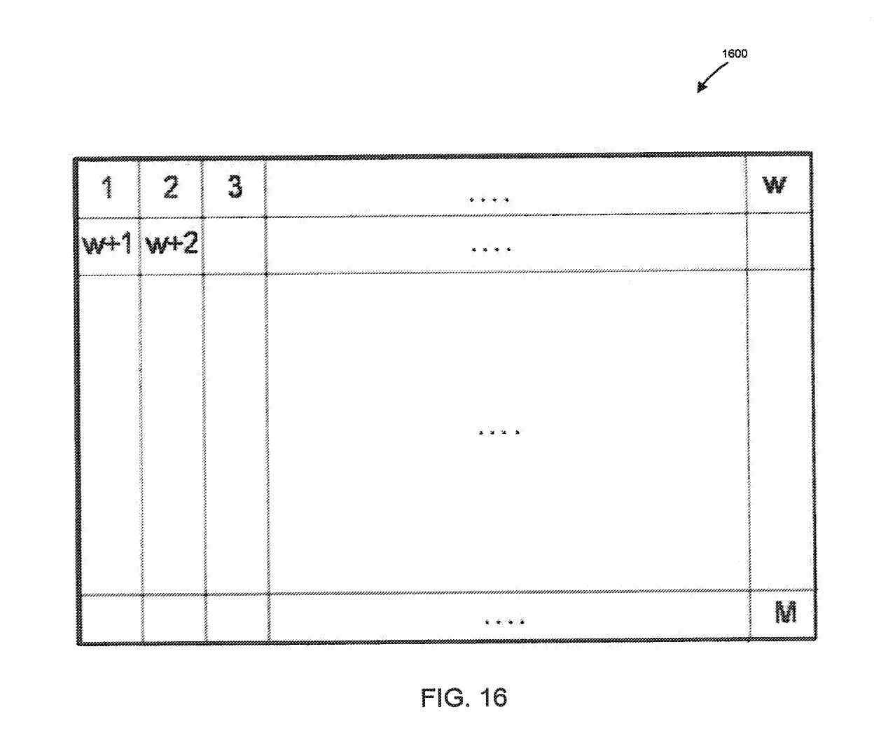

FIG. 16 is a diagram showing an exemplary block ID, in accordance with an embodiment of the present principles;

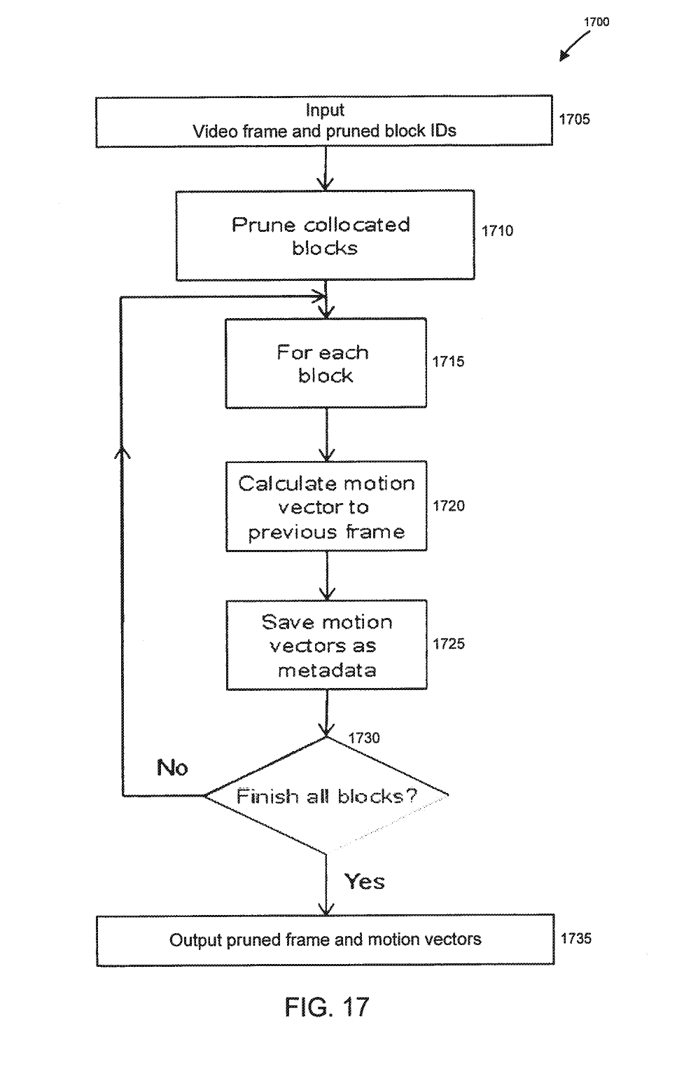

FIG. 17 is a flow diagram showing an exemplary method for pruning subsequent frames, in accordance with an embodiment of the present principles;

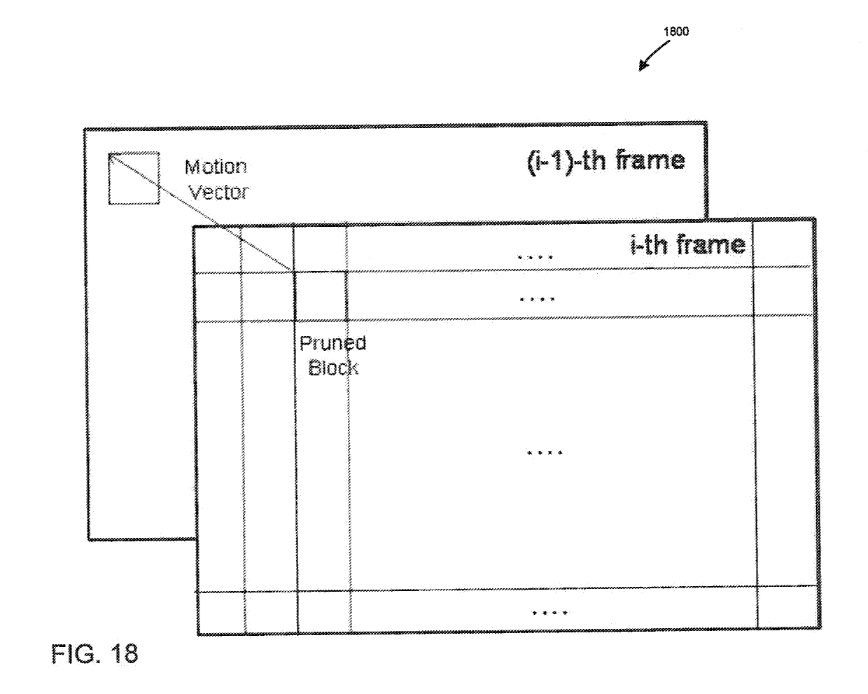

FIG. 18 is a diagram showing an exemplary motion vector for a pruned block, in accordance with an embodiment of the present principles;

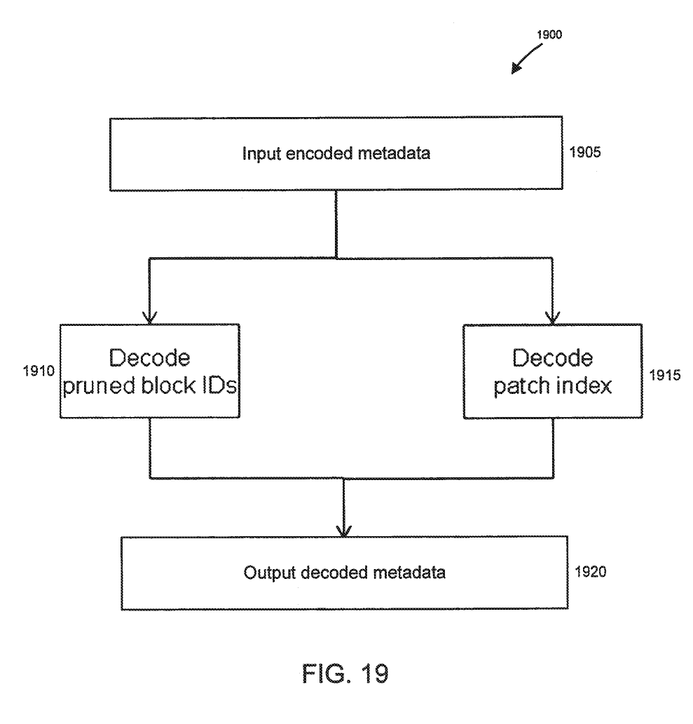

FIG. 19 is a flow diagram showing an exemplary method for decoding metadata, in accordance with an embodiment of the present principles;

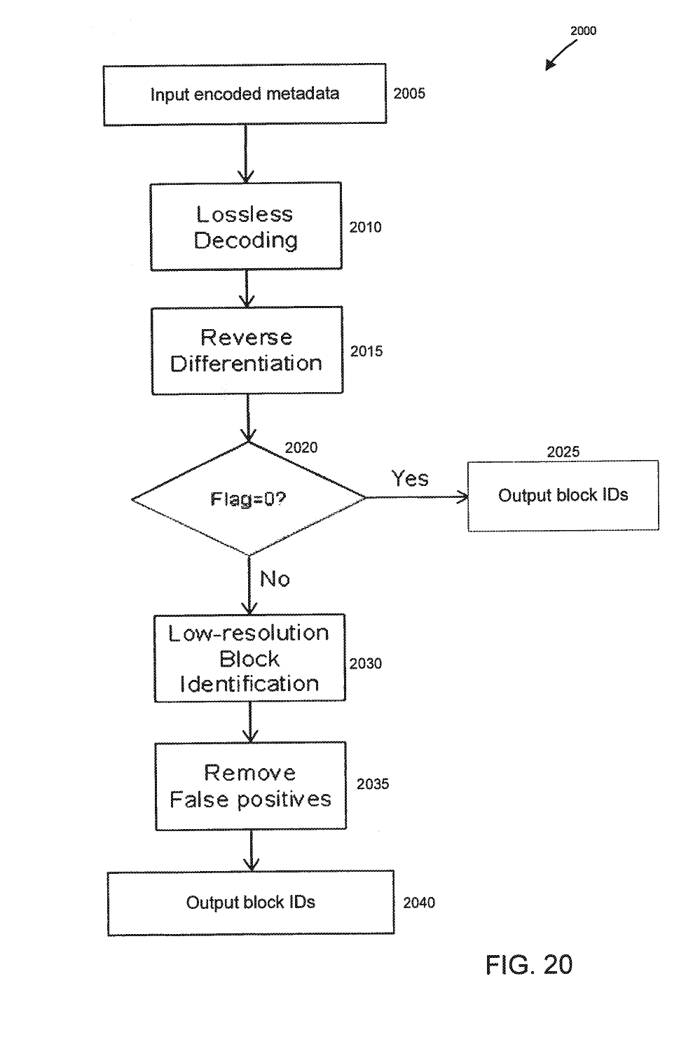

FIG. 20 is a flow diagram showing an exemplary method for decoding pruned block IDs, in accordance with an embodiment of the present principles;

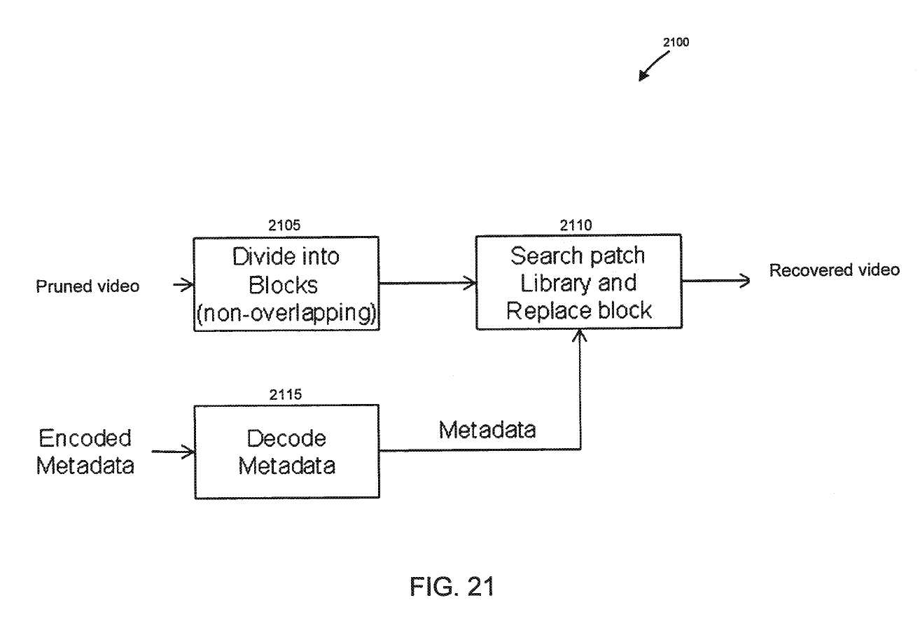

FIG. 21 is a block diagram showing an exemplary apparatus for performing decoder side processing for example-based data pruning, in accordance with an embodiment of the present principles;

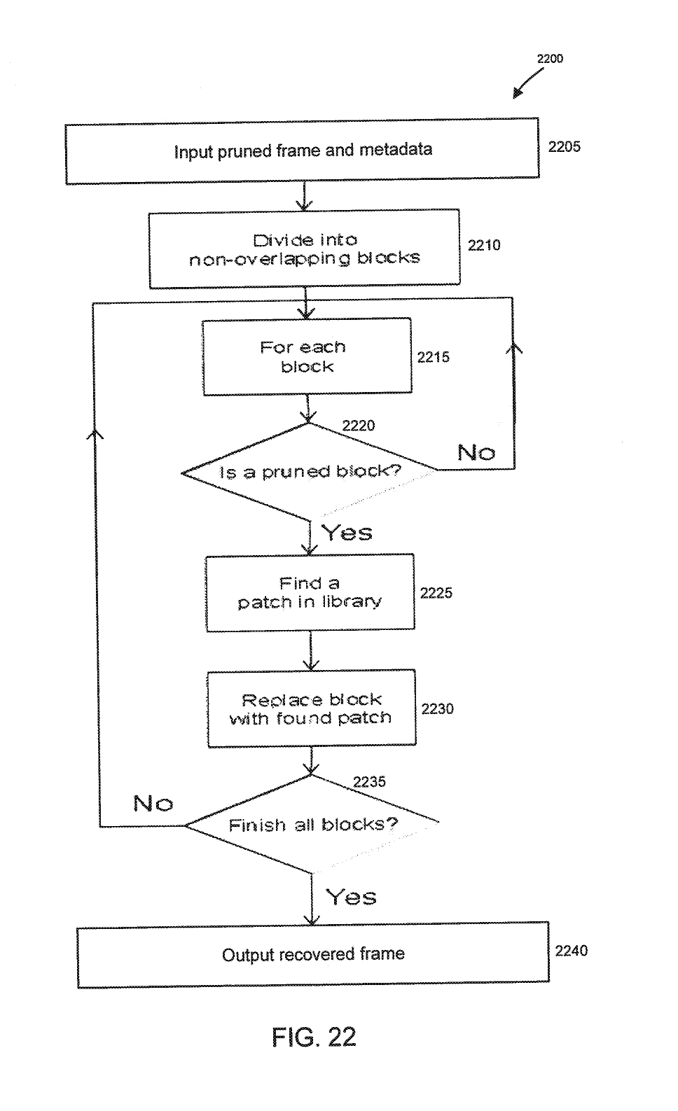

FIG. 22 is a flow diagram showing an exemplary method for recovering a pruned frame, in accordance with an embodiment of the present principles; and

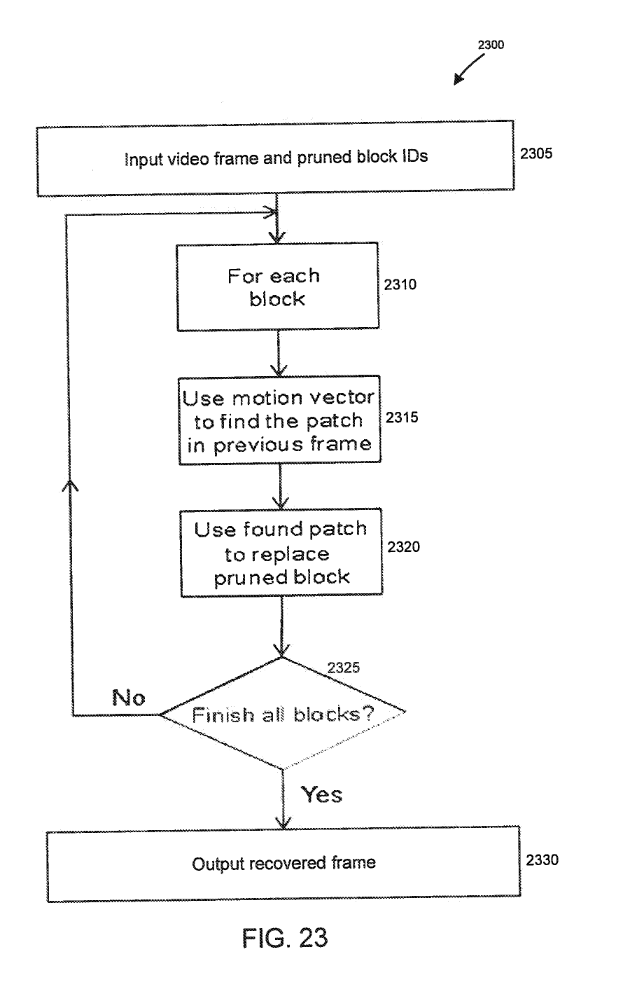

FIG. 23 is a flow diagram showing an exemplary method for recovering subsequent frames, in accordance with an embodiment of the present principles.

The present principles are directed to methods and apparatus for example-based data pruning for improving video compression efficiency.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Also, as used herein, the words “picture” and “image” are used interchangeably and refer to a still image or a picture from a video sequence. As is known, a picture may be a frame or a field.

Turning to FIG. 1, an exemplary example-based data pruning system is indicated generally by the reference numeral 100. The pruning system 100 includes a pruner 105 having an output connected in signal communication with an input of a video encoder 110 and a first input of a metadata generator and encoder 135. An output of the video encoder is connected in signal communication with an input of a video decoder 115 and an input of a patch library creator 140. An output of the video decoder 115 is connected in signal communication with a first input of a recovery device 120. An output of the patch library creator 130 is connected in signal communication with a second input of the recovery device 120. An output of the metadata generator and encoder 135 is connected in signal communication with an input of a metadata decoder 125. An output of the metadata decoder 125 is connected in signal communication with a third input of the recovery device 120. An output of the patch library creator 140 is connected in signal communication with a second input of the metadata generator and encoder 135. An output of a clustering device and patch library creator 145 is connected in signal communication with a second input of the pruner 105. An input of the pruner 105 and an input of the clustering device and patch library creator 145 are available as inputs to the pruning system 100, for receiving input video. An output of the recovery device is available as an output of the pruning system 100, for outputting video.

Turning to FIG. 2, an exemplary video encoder to which the present principles may be applied is indicated generally by the reference numeral 200. The video encoder 200 includes a frame ordering buffer 210 having an output in signal communication with a non-inverting input of a combiner 285. An output of the combiner 285 is connected in signal communication with a first input of a transformer and quantizer 225. An output of the transformer and quantizer 225 is connected in signal communication with a first input of an entropy coder 245 and a first input of an inverse transformer and inverse quantizer 250. An output of the entropy coder 245 is connected in signal communication with a first non-inverting input of a combiner 290. An output of the combiner 290 is connected in signal communication with a first input of an output buffer 235.

A first output of an encoder controller 205 is connected in signal communication with a second input of the frame ordering buffer 210, a second input of the inverse transformer and inverse quantizer 250, an input of a picture-type decision module 215, a first input of a macroblock-type (MB-type) decision module 220, a second input of an intra prediction module 260, a second input of a deblocking filter 265, a first input of a motion compensator 270, a first input of a motion estimator 275, and a second input of a reference picture buffer 280.

A second output of the encoder controller 205 is connected in signal communication with a first input of a Supplemental Enhancement Information (SEI) inserter 230, a second input of the transformer and quantizer 225, a second input of the entropy coder 245, a second input of the output buffer 235, and an input of the Sequence Parameter Set (SPS) and Picture Parameter Set (PPS) inserter 240.

An output of the SEI inserter 230 is connected in signal communication with a second non-inverting input of the combiner 290.

A first output of the picture-type decision module 215 is connected in signal communication with a third input of the frame ordering buffer 210. A second output of the picture-type decision module 215 is connected in signal communication with a second input of a macroblock-type decision module 220.

An output of the Sequence Parameter Set (SPS) and Picture Parameter Set (PPS) inserter 240 is connected in signal communication with a third non-inverting input of the combiner 290.

An output of the inverse quantizer and inverse transformer 250 is connected in signal communication with a first non-inverting input of a combiner 219. An output of the combiner 219 is connected in signal communication with a first input of the intra prediction module 260 and a first input of the deblocking filter 265. An output of the deblocking filter 265 is connected in signal communication with a first input of a reference picture buffer 280. An output of the reference picture buffer 280 is connected in signal communication with a second input of the motion estimator 275 and a third input of the motion compensator 270. A first output of the motion estimator 275 is connected in signal communication with a second input of the motion compensator 270. A second output of the motion estimator 275 is connected in signal communication with a third input of the entropy coder 245.

An output of the motion compensator 270 is connected in signal communication with a first input of a switch 297. An output of the intra prediction module 260 is connected in signal communication with a second input of the switch 297. An output of the macroblock-type decision module 220 is connected in signal communication with a third input of the switch 297. The third input of the switch 297 determines whether or not the “data” input of the switch (as compared to the control input, i.e., the third input) is to be provided by the motion compensator 270 or the intra prediction module 260. The output of the switch 297 is connected in signal communication with a second non-inverting input of the combiner 219 and an inverting input of the combiner 285.

A first input of the frame ordering buffer 210 and an input of the encoder controller 205 are available as inputs of the encoder 200, for receiving an input picture. Moreover, a second input of the Supplemental Enhancement Information (SEI) inserter 230 is available as an input of the encoder 200, for receiving metadata. An output of the output buffer 235 is available as an output of the encoder 200, for outputting a bitstream.

Turning to FIG. 3, an exemplary video decoder to which the present principles may be applied is indicated generally by the reference numeral 300. The video decoder 300 includes an input buffer 310 having an output connected in signal communication with a first input of an entropy decoder 345. A first output of the entropy decoder 345 is connected in signal communication with a first input of an inverse transformer and inverse quantizer 350. An output of the inverse transformer and inverse quantizer 350 is connected in signal communication with a second non-inverting input of a combiner 325. An output of the combiner 325 is connected in signal communication with a second input of a deblocking filter 365 and a first input of an intra prediction module 360. A second output of the deblocking filter 365 is connected in signal communication with a first input of a reference picture buffer 380. An output of the reference picture buffer 380 is connected in signal communication with a second input of a motion compensator 370.

A second output of the entropy decoder 345 is connected in signal communication with a third input of the motion compensator 370, a first input of the deblocking filter 365, and a third input of the intra predictor 360. A third output of the entropy decoder 345 is connected in signal communication with an input of a decoder controller 305. A first output of the decoder controller 305 is connected in signal communication with a second input of the entropy decoder 345. A second output of the decoder controller 305 is connected in signal communication with a second input of the inverse transformer and inverse quantizer 350. A third output of the decoder controller 305 is connected in signal communication with a third input of the deblocking filter 365. A fourth output of the decoder controller 305 is connected in signal communication with a second input of the intra prediction module 360, a first input of the motion compensator 370, and a second input of the reference picture buffer 380.

An output of the motion compensator 370 is connected in signal communication with a first input of a switch 397. An output of the intra prediction module 360 is connected in signal communication with a second input of the switch 397. An output of the switch 397 is connected in signal communication with a first non-inverting input of the combiner 325.

An input of the input buffer 310 is available as an input of the decoder 300, for receiving an input bitstream. A first output of the deblocking filter 365 is available as an output of the decoder 300, for outputting an output picture.

As noted above, the present principles are directed to methods and apparatus for example-based data pruning for improving video compression efficiency. Advantageously, the present principles provide an improvement over the aforementioned seventh approach. That is, the present application discloses a concept of training the patch library at the decoder side using previously sent frames or existing frames, rather than sending the patch library through a communication channel as per the seventh approach. Also, the data pruning is realized by replacing some blocks in the input frames with flat regions to create “mixed resolution” frames.

In an embodiment, the present principles advantageously provide for the use of a patch example library trained from a pool of training images/frames to prune a video and recover the pruned video. The patch example library can be considered as an extension of the concept of a reference frame. Therefore, the patch example library idea can be also used in conventional video encoding schemes. In an embodiment, the present principles use error-bounded clustering (e.g., modified K-means clustering) for efficient patch searching in the library.

Moreover, in an embodiment, the present principles advantageously provide a mixed-resolution data-pruning scheme, where blocks are replaced by flat blocks to reduce the high-frequency signal to improve compression efficiency. To increase the efficiency of the metadata (best-match patch position in library) encoding, the present principles use patch signature matching, a matching rank list, and rank number encoding.

Additionally, in an embodiment, the present principles advantageously provide a strategy of encoding pruned block IDs using a flat block identification scheme based on color variation.

Thus, in accordance with the present principles, a novel method, referred to herein as example-based data pruning, is provided for pruning an input video so that the video can be more efficiently encoded by video encoders. In an embodiment, the method involves creating a library of patches as examples, and using the patch library to recover a video frame in which some blocks in the frame are replaced with low-resolution blocks or flat blocks. The framework includes the methods to create the patch library, prune the video, recover the video, as well as encode the metadata needed for recovery.

Referring to FIG. 1, encoder-side processing essentially includes two parts, namely patch library creation and pruning. A patch library can be created using previous frames (original video frames or encoded and decoded frames) that have been sent to the decoder side or using some videos that are shared or can be accessed by both the encoder side and the decoder side (e.g., videos from YOUTUBE.COM). In a preferred embodiment disclosed herein, the previously existing frames are used to create the patch library. A patch library is generated at the decoder side also using the previously decoded frames. Two patch libraries are generated at the encoder side. One library is generated from the original frame, and the other library is generated from the reconstructed frame (i.e., an encoded and then decoded frame). The latter (the library generated from the reconstructed frame) is exactly the same as the patch library created at the decoder side because they use exactly the same frame (i.e., the reconstructed frame) to generate the patch libraries.

At the encoder side, the patch library created from the original frame is used to prune the blocks, whereas the patch library created from the reconstructed frame is used to encode metadata. The reason of using the patch library created from the reconstructed frame is to make sure the patch libraries for encoding and decoding metadata are identical at the encoder side and the decoder side.

For the patch library created using the original frames, a clustering algorithm is performed to group the patches so that the patch search process during pruning can be efficiently carried out. Pruning is a process to modify the source video using the patch library so that less bits are sent to the decoder side. Pruning is realized by dividing a video frame into blocks, and replacing some of the blocks with low resolution or flat blocks. The pruned frame is then taken as the input for a video encoder. An exemplary video encoder to which the present principles may be applied is shown in FIG. 2 described above.

Referring back to FIG. 1, the decoder-side processing component of the pruning system 100 can also be considered to include two parts, namely a patch library creation part and a recovery part. Patch library creation at the decoder side is a process to create a patch library using the previously decoded frames, which should be the same for both encoder and decoder sides. Different from the encoder side processing, clustering is not used in patch library creation at the decoder side. The recovery component is a process to recover the pruned content in the decoded pruned frames sent from the encoder side. The decoded pruned frame is the output of a video decoder. An exemplary video decoder to which the present principles may be applied is shown in FIG. 3 described above.

### Patch Library Creation

Turning to FIG. 4, an exemplary first portion for performing encoder side processing in an example-based data pruning system is indicated generally by the reference numeral 400. The first portion 400 includes a divider 410 having an output in signal communication with an input of a clustering device 420. An input of the divider is available as an input to the first portion 400, for receiving training frames. An output of the clustering device 420 is available as an output of the first portion 400, for outputting clusters and a patch library.

Turning to FIG. 5, an exemplary method for clustering and patch library creation is indicated generally by the reference numeral 500. At step 505, a training video frame is input. At step 510, the training video frame is divided (by divider 410) into overlapping blocks. At step 515, blocks without high-frequency details are removed (by the clustering device 420). At step 520, the blocks are clustered (by the clustering device 420). At step 525, clusters and a patch library are output.

The patch library is a pool of high resolution patches that can be used to recover pruned image blocks. Turning to FIG. 6, an exemplary patch library and corresponding clusters are indicated generally by the reference numeral 600. The patch library is specifically indicated by the reference numeral 610, and includes a signature portion 611 and a high resolution patch portion 612. For the encoder side processing, two patch libraries are generated, one patch library for pruning, the other patch library for metadata encoding. The patch library for pruning is generated using the original frame, whereas the patch library for metadata encoding is generated using the reconstructed frame. For the patch library for pruning, the patches in the library are grouped into clusters so that the pruning search process can be efficiently performed. The video frames used for library creation are divided into overlapping blocks to form a training data set. The training data is first cleaned up by removing all blocks that do not include high-frequency details. A modified K-means clustering algorithm—described in Dong-Qing Zhang, Sitaram Bhagavathy, and Joan Llach, “Data pruning for video compression using example-based super-resolution”, filed as a commonly-owned U.S. Provisional Patent Application (Ser. No. 61/336,516) on Jan. 22, 2010 (Technicolor docket number PU100014)—is used to group the patches in the training data set into clusters. For each cluster, the cluster center is the average of the patches in the cluster, and is used for matching an incoming query during the pruning process. The modified K-means clustering algorithm ensures that the error between any patch within a cluster and its cluster center is smaller than a specified threshold. The modified K-means clustering algorithm could be replaced by any similar clustering algorithm which ensures the error bound in the clusters.

To speed up computation, the horizontal and vertical dimensions of the training frames are reduced to one quarter of the original size. Also, the clustering process is performed on the patches in the downsized frames. In one exemplary embodiment, the size of the high-resolution patches is 16×16 pixels, and the size of the downsized patches is 4×4 pixels. Therefore, the downsize factor is 4. Of course, other sizes can be used, while maintaining the spirit of the present principles.

For the patch library for metadata encoding, the clustering process and clean-up process are not performed; therefore, it includes all possible patches from the reconstructed frame. However, for every patch in the patch library created from the original frames, it is possible to find its corresponding patch in the patch library created from the reconstructed frame using the coordinates of the patches. This would make sure that metadata encoding can be correctly performed. For the decoder side, the same patch library without clustering is created using the same decoded video frames for metadata decoding and pruned block recovery.

For the patch libraries created using decoded frames at both encoder and decoder sides, another process is conducted to create the signatures of the patches. The signature of a patch is a feature vector that includes the average color of the patch and the surrounding pixels of the patch. The patch signatures are used for the metadata encoding process to more efficiently encode the metadata, and used in the recovery process at the decoder side to find the best-match patch and more reliably recover the pruned content. Turning to FIG. 7, an exemplary signature vector is indicated generally by the reference numeral 700. The signature vector 700 includes an average color 701 and surrounding pixels 702.

The metadata encoding process is described herein below. In the pruned frame, sometimes the neighboring blocks of a pruned block for recovery or metadata encoding are also pruned. Then the set of surrounding pixels used as the signature for search in the patch library only includes the pixels from the non-pruned blocks. If all the neighboring blocks are pruned, then only the average color 701 is used as the signature. This may end up with bad patch matches since too little information is used for patch matching, that is why neighboring non-pruned pixels 702 are important.

### Pruning Process

Similar to standard video encoding algorithms, the input video frames are divided into Group of Pictures (GOP). The pruning process is conducted on the first frame of a GOP. The pruning result is propagated to the rest of the frames in the GOP afterwards.

### Pruning Process for the First Frame in a GOP

Turning to FIG. 8, an exemplary second portion for performing encoder side processing in an example-based data pruning system is indicated generally by the reference numeral 800. The second portion 800 includes a divider 805 having an output in signal communication with an input of a patch library searcher 810. An output of the patch library searcher 810 is connected in signal communication with an input of a video encoder 815, a first input of a metadata generator 820, and a first input of a metadata encoder 825. An output of the metadata generator 820 is connected in signal communication with a second input of the metadata encoder 825. A first output of the video encoder 815 is connected in signal communication with a second input of the metadata generator 820. An input of the divider 805 is available as an input of the second portion 800, for receiving an input frame. An output of the video encoder 815 is available as an output of the second portion 800, for outputting an encoded video frame. An output of the metadata encoder 825 is available as an output of the second portion 800, for outputting encoded metadata.

Turning to FIG. 9, an exemplary method for pruning a video frame is indicated generally by the reference numeral 900. At step 905, an video frame is input. At step 910, the video frame is divided into non-overlapping blocks. At step 915, a loop is performed for each block. At step 920, a search is performed in the patch library. At step 925, it is determined whether or not a patch has been found. If the patch has been found, then the method proceeds to step 930. Otherwise, the method returns to step 915. At step 930, the block is pruned. At step 935, it is determined whether or not all blocks have been finished. If all blocks have been finished, then the method proceeds to step 940. Otherwise, the method returns to step 915. At step 940, the pruned frame and corresponding metadata are output.

Thus, the input frame is first divided into non-overlapping blocks per step 910. The size of the block is the same as the size of the macroblock used in the standard compression algorithms—the size of 16×16 pixels is employed in the exemplary implementation disclosed herein. A search process then is followed to find the best-match patch in the patch library per step 920. This search process is illustrated in FIG. 10. Turning to FIG. 10, a patch search process performing during pruning is indicated generally by the reference numeral 1000. The patch search process 1000 involves a patch library 1010 which, in turn, includes a signature portion 1011 and a high resolution patch portion 1012. First, the block is matched with the centers of the clusters by calculating the Euclidean distance, and finding the top K matched clusters. Currently, K is determined empirically. In principle, K is determined by the error bound of the clusters. Of course, other approaches to calculate K may also be used in accordance with the teachings of the present principles. After the candidate clusters are identified, the search process is conducted within the clusters until the best-match patch is found in the clusters. If the difference between the best-match patch and the query block is less than a predetermined threshold, the block would be pruned. Otherwise, the block will be kept intact. The IDs of the pruned blocks and the index of the best-match patches for each block are saved as metadata, which will be encoded in the metadata encoding component and sent to the decoder side.

After the blocks are identified for pruning, a process is conducted to prune the block. There could be different pruning strategies for the blocks that need to be pruned—for example, replacing the high-resolution blocks with low-resolution blocks. However, it has been discovered that it may be difficult for this approach to achieve significant compression efficiency gain. Therefore, in a preferred embodiment disclosed herein, a high-resolution block is simply replaced with a flat block, in which all pixels have the same color value (i.e., the average of the color values of the pixels in the original block). The block replacement process creates a video frame where some parts of a frame have high-resolution and some other parts have low-resolution; therefore, such a frame is called as a “mixed-resolution” frame (for more details on the mixed-resolution pruning scheme, see the co-pending commonly-owned International (PCT) Patent Application Serial No. ______ entitled METHODS AND APPARATUS FOR ENCODING VIDEO SIGNALS FOR BLOCK-BASED MIXED-RESOLUTION DATA PRUNING FOR IMPROVING VIDEO COMPRESSION EFFICIENCY filed on Mar. ______, 2011 (Technicolor Docket No. PU100194). Turning to FIG. 11, an exemplary mixed-resolution frame is indicated generally by the reference numeral 1100. It has been discovered that the flat-block replacement scheme described above is quite effective to gain desirable compression efficiency. The flat block replacement scheme could be replaced by a low-resolution block replacement scheme, where the block for pruning is replaced by its low-resolution version.

### Metadata Encoding and Decoding

Metadata encoding includes two components (see FIG. 12), one for encoding pruned block IDs (see FIG. 13), the other for encoding patch index (FIG. 14), which are the results of searching patch library for each block during the pruning process.

Turning to FIG. 12, an exemplary method for encoding metadata is indicated generally by the reference numeral 1200. At step 1205, a decoded pruned video frame, pruned block IDs, and a patch index for each block are input. At step 1210, pruned block IDs are encoded. At step 1215, the patch index is encoded. At step 1220, the encoded metadata is output.

Turning to FIG. 13, an exemplary method for encoding pruned block IDs is indicated generally by the reference numeral 1300. At step 1305, a pruned frame and pruned block IDs are input. At step 1310, a low-resolution block identification is performed. At step 1320, it is determined whether or not there are any misses. If no miss is determined, then the method proceeds to step 1325. Otherwise, the method proceeds to step 1315. At step 1325, it is determined whether or not the number of false positives is more than the number of pruned blocks. If the number of false positives is more than that of pruned blocks, then the method proceeds to step 1330. Otherwise, control proceeds to step 1335. At step 1330, the pruned block sequence is used, and a flag is set equal to zero. At step 1340, a differentiation is performed. At step 1345, lossless encoding is performed. At step 1350, the encoded metadata is output. At step 1315, a threshold is adjusted. At step 1335, the false positive sequence is used, and the flag is set equal to one.

Turning to FIG. 14, an exemplary method for encoding a patch index is indicated generally by the reference numeral 1400. At step 1405, a decoded pruned video frame and a patch index for each block are input. At step 1410, a loop is performed for each pruned block. At step 1415, a signature is obtained. At step 1420, the distances to the patches in the patch library are calculated. At step 1425, the patches are sorted to obtain a rank list. At step 1430, the rank number is obtained. At step 1435, the rank number is entropy coded. At step 1440, it is determined whether or not all blocks are finished (being processed). If all blocks are finished, then the method proceeds to step 1445. Otherwise, the method returns to step 1410. At step 1445, the encoded patch index is output.

During the pruning process, for each block, the system would search the best match patch in the patch library and output a patch index in the patch library for a found patch if the distortion is less than a threshold. Each patch is associated with its signature (i.e., its color plus surrounding pixels in the decoded frames). During the recovery process in the decoder side processing, the color of the pruned block and its surrounding pixels are used as a signature to find the correct high-resolution patch in the library.

However, due to noise, the search process using the signature is not reliable, and metadata is needed to assist the recovery process to ensure reliability. Therefore, after the pruning process, the system will proceed to generate metadata for assisting recovery. For each pruned block, the search process described above already identifies the corresponding patches in the library. The metadata encoding component will simulate the recovery process by using the query vector (the average color of the pruned block plus the surrounding pixels) to match the signatures of the patches in the patch library (the library created using the decoded frame). The process is illustrated in FIG. 14. Referring back to FIG. 14, for each block, the distances (e.g., Euclidean, although, of course, other distance metrics may be used) between the query vector corresponding to the block and the signatures of the patches in the library are calculated. The patches are sorted according to the distances, resulting in a rank list. In the ideal case, the best-match high-resolution patch should be at the top of the rank list. However, due to the noise caused by arithmetic rounding and compression, the best-match patch is often not the first one in the rank list. Presume that the correct patch is the n^{th} patch in the rank list. The number n will be saved as the metadata for the block. It should be noted that, in the most cases, n is 1 or very small number because the best-match patch is close to the top in the rank list; therefore, the entropy of this random number is significantly smaller than the index of the best-match patch in the library, which should be a uniform distribution having maximum entropy. Therefore, the order number can be efficiently encoded by entropy coding. The rank numbers of all the pruned blocks form a rank number sequence as part of the metadata sent to the decoder side. It has been discovered by actual experiments that the distribution of the rank numbers is close to a geometric distribution; therefore, currently the Golomb code is used for further encoding the rank number sequence. Golomb code is optimal for a random number having geometric distribution. Of course, other types of codes may also be used in accordance with the teachings of the present principles, while maintaining the spirit of the present principles.

For decoding (see FIG. 15), the decoder side should have exactly the same patch library as the encoder, which is created using decoded frames. The signature of the pruned block will be used to match with the signatures in the patch library and get a rank list (the sorted patch library). The rank number is used to retrieve the correct patch from the sorted patch library. If the patch library is created from previous frames, in order to ensure the encoder and decoder side has exactly the same patch library, the metadata encoding process at the encoder side should also use the decoded frames from the video decoder because only the decoded frames are available at the decoder side.

Turning to FIG. 15, an exemplary method for decoding a patch index is indicated generally by the reference numeral 1500. At step 1505, a decoded pruned video frame, an encoded patch index, and pruned block IDs are input. At step 1510, a loop is performed for each pruned block. At step 1515, a signature is obtained. At step 1520, the distances to the patches in the patch library are calculated. At step 1525, the patches are sorted to obtain a rank list. At step 1530, the encoded rank number is entropy decoded. At step 1535, the patch index is retrieved from the patch library using the rank number. At step 1540, it is determined whether or not all blocks are finished (being processed). If all blocks are finished, then the method proceeds to step 1545. Otherwise, the method returns to step 1510. At step 1545, the decoded patch index is output.

Besides the rank number metadata, the locations of the pruned blocks need to be sent to the decoder side. This is done by block ID encoding (see FIG. 13). One simple way may be to just send a block ID sequence to the decoder side. The ID of a block indicates the coordinate of the block on the frame. Turning to FIG. 16, an exemplary block ID is indicated generally by the reference numeral 1600. It may also be possible to more efficiently encode the ID sequence of the pruned blocks. Because the pruned blocks are flat and contain no high-frequency components, it is possible to detect the pruned blocks by calculating the color variation within the block. If the color variation is smaller than a threshold, then the block is identified as a pruned block. However, since such an identification process may not be reliable, metadata are still needed to facilitate the identification process. First, the variance threshold is determined by starting from a high threshold value. The algorithm then slowly decreases the variance threshold such that all pruned blocks can be identified by the identification procedure, but false positive blocks may be present in the identified results. Afterwards, if the number of the false positives is larger than that of the pruned blocks, the IDs of the pruned blocks are saved and sent to decoder; otherwise, the IDs of the false positives would be sent to the decoder side. The variance threshold for identifying flat blocks is also sent to the decoder side for running the same identification procedure. The ID sequence can be sorted so that the numbers are increasing.

To further reduce redundancy, a differential coding scheme is employed to first compute the difference between an ID number and its previous ID number, and encode the difference sequence. For example, assuming the ID sequence is 3, 4, 5, 8, 13, 14, the differentiated sequence becomes 3, 1, 1, 3, 5, 1. The differentiation process makes the numbers closer to 1, therefore resulting in a number distribution with smaller entropy. The differentiated sequence then can be further encoded with entropy coding (e.g., Huffman coding in the current implementation). Thus, the format of the final metadata is shown as follows:

| | | | |
|---|---|---|---|
| Flag | Threshold | Encoded block ID Sequence | Encoded rank number |
| | | | sequence |

where flag is a signaling flag to indicate whether or not the block ID sequence is a false positive ID sequence; the threshold is the variance threshold for flat block identification; the encoded block ID sequence is the encoded bit stream of the pruned block IDs or the false positive block IDs; and the encoded rank number sequence is the encoded bit stream of the rank numbers used for block recovery.

### Pruning Process for the Rest of Frames

For the rest of the frames in a GOP, some of the blocks in the frames will be also replaced by flat blocks. The positions of the pruned blocks in the first frame can be propagated to the rest of the frames by motion tracking. Different strategies to propagate the positions of the pruned blocks have been tested. One approach is to track the pruned blocks across frames by block matching, and prune the corresponding blocks in the subsequent frames (i.e., replace the tracked blocks with flat blocks). However, this approach does not result in good compression efficiency gain because, in general, the boundaries of the tracked blocks do not align with the coding macro blocks. As a result, the boundaries of the tracked blocks create a high frequency signal in the macroblocks. Therefore, a simpler alternative approach is currently used to set all the block positions for the subsequent frames to the same positions as the first frame. Namely, all the pruned blocks in the subsequent frames are co-located with the pruned blocks in the first frame. As a result, all of the pruned blocks for the subsequent frames are aligned with macro block positions.

However, this approach may not work well if there is motion in the pruned blocks. Therefore, one solution to solve the problem is to calculate the motion intensity of the block (see FIG. 17). Turning to FIG. 17, an exemplary method for pruning sequent frames is indicated generally by the reference numeral 1700. At step 1705, a video frame and pruned block IDs are input. At step 1710, co-located blocks are pruned. At step 1715, a loop is performed for each block. At step 1720, a motion vector is calculated to the previous frame. At step 1725, the motion vectors are saved as metadata. At step 1730, it is determined whether or not all blocks are finished (being processed). If all blocks are finished, then the method proceeds to step 1735. Otherwise, the method returns to step 1715.

If the motion intensity is larger than a threshold, the block would not be pruned. Another more sophisticated solution, which is an exemplary implementation disclosed herein, is to calculate the motion vectors of the pruned blocks in the original video by searching the corresponding block in the previous frame (see FIG. 18). Turning to FIG. 18, an exemplary motion vector for a pruned block is indicated generally by the reference numeral 1800. The motion vector 1800 relates to a pruned block in an i-th frame and a co-located block in a (i−1)-th frame. The motion vectors of the pruned blocks would be sent to the decoder side for a recovery purpose. Since the previous frame would already have been completely recovered, the pruned blocks in the current frame can be recovered using the motion vectors. To avoid artifacts, if the difference between the block in the current frame and the corresponding block calculated by motion estimation in the previous frame is too large, then the block in the current frame would not be pruned. Furthermore, sub-pixel motion estimation is currently employed to make motion vector based recovery more accurate. It has been discovered by experiments that the resultant visual quality using sub-pixel based motion vector estimation is much better than that using integer pixel based motion vector estimation.

### Recovery Process

The recovery process takes place at the decoder side. Before the recovery process, the patch library should be created. For long videos, such as movies, this could be achieved by using previous frames already sent to the decoder side. The encoder side can send metadata (the frame IDs) indicating which frames should be used to create the patch library. The patch library at the decoder side should be exactly the same as that at the encoder side

For the first frame in a GOP, the recovery process starts with decoding the metadata (see FIG. 19), including decoding the block ID sequence (see FIG. 20) and the rank order sequence (see FIG. 19). Turning to FIG. 19, an exemplary method for decoding metadata is indicated generally by the reference numeral 1900. At step 1905, encoded metadata is input. At step 1910, pruned block IDs are decoded. At step 1915, a patch index is decoded. At step 1920, decoded metadata is output.

Turning to FIG. 20, an exemplary method for decoding pruned block IDs is indicated generally by the reference numeral 2000. At step 2005, encoded metadata is input. At step 2010, lossless decoding is performed. At step 2015, reverse differentiation is performed. At step 2020, it is determined whether or not a flag is equal to zero. If the flag is equal to zero, then the method proceeds to step 2025. Otherwise, the method proceeds to step 2030. At step 2025, block IDs are output. At step 2030, a low resolution block identification is performed. At step 2035, false positives are removed. At step 2040, block IDs are output.

After the block ID sequence is available, for each pruned block, the average color and the surrounding pixels of this block will be taken as the signature vector to match with the signatures in the patch library. However, if the neighboring blocks of the block for recovery are also pruned, then the set of surrounding pixels used as the signature for search only includes the pixels from the non-pruned blocks. If all the neighboring blocks are pruned, then only the average color is used as the signature. The matching process is realized by calculating the Euclidean distances between the signature of the query block and those of the patches in the library. After all the distances are calculated, the list is sorted according to the distances, resulting in a rank list. The rank number corresponding to the pruned block then is used to retrieve the correct high-resolution block from the rank list.

Turning to FIG. 21, an exemplary apparatus for performing decoder side processing for example-based data pruning is indicated generally by the reference numeral 2100. The apparatus 2100 includes a divider 2105 having an output connected in signal communication with a first input of a search patch library and block replacement device 2110. An output of a metadata decoder 2115 is connected in signal communication with a second input of the search patch library and block replacement device 2110. An input of the divider 2105 is available as an input of the apparatus 2100, for receiving pruned video. An input of the metadata decoder 2115 is available as an input of the apparatus 2100, for receiving encoded metadata. An output of the search patch library and block replacement device 2110 is available as an output of the apparatus, for outputting recovered video.

Turning to FIG. 22, an exemplary method for recovering a pruned frame is indicated generally by the reference numeral 2200. At step 2205, a pruned frame and corresponding metadata are input. At step 2210, the pruned frame is divided into non-overlapping blocks. At step 2215, a loop is performed for each block. At step 2220, it is determined whether or not the current block is a pruned block. If the current block is a pruned block, then the method proceeds to step 2225. Otherwise, the method returns to step 2215. At step 2225, a patch is found in the library. At step 2230, a current block is replaced with the found patch. At step 2235, it is determined whether or not all blocks are finished (being processed). If all blocks are finished, then the method proceeds to step 2240. Otherwise, the method returns to step 2215. At step 2240, the recovered frame is output.

It is to be appreciated that the block recovery using example patches can be replaced by traditional inpainting and texture synthesis based methods.

For the rest of the frames in a GOP, for each pruned block, if the motion vector is not available, the content of the block can be copied from the co-located block in the previous frame. If the motion vector is available, the motion vector can be used to find the corresponding block in the previous frame, and copy the corresponding block to fill the pruned block (see FIG. 23). Turning to FIG. 23, an exemplary method for recovering subsequent frames is indicated generally by the reference numeral 2300. At step 2305, a video frame and pruned block IDs are input. At step 2310, a loop is performed for each block. At step 2315, a motion vector is used to find the patch in the previous frame. At step 2320, the found patch is used to replace the pruned block. At step 2325, it is determined whether or not all blocks are finished (being processed). If all blocks are finished, then the method proceeds to step 2330. Otherwise, the method returns to step 2310.

Block artifacts may be visible since the recovery process is block-based. A deblocking filter, such as the in-loop deblocking filter used in AVC encoder, can be applied to reduce the block artifacts.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. An apparatus, comprising:
a patch library creator for creating a first patch library from an original version of a picture in a video sequence and a second patch library from a reconstructed version of said picture in said video sequence, each of said first patch library and said second patch library including a plurality of high resolution replacement patches for replacing one or more pruned blocks during a recovery of a pruned version of said picture; and
a pruner for generating said pruned version of said picture said first patch library;
a metadata generator for generating metadata from said second patch library for use in recovering said pruned version of said picture; and
an encoder for encoding said pruned version of said picture and said metadata.

2. The apparatus of claim 1, wherein said pruned version of said picture is generated by dividing said original version of said picture into a plurality of blocks, and respectively replacing at least one of said plurality of blocks with a replacement patch, wherein all pixels in said replacement patch have one of a same color value or a low resolution.

3. The apparatus of claim 2, wherein said same color value is equal to an average of color values of said pixels within said at least one of said plurality of blocks.

4. The apparatus of claim 1, wherein said first patch library is created by dividing said original version of said picture into a plurality of overlapping blocks to form a training data set, removing any of said plurality of overlapping blocks from said training set having a high frequency component above a pre-specified threshold, and clustering remaining ones of said plurality of overlapping blocks into a plurality of clusters, wherein each of said remaining ones of said plurality of overlapping blocks form a respective one of said plurality of high resolution replacement patches.

5. The apparatus of claim 4, wherein a respective center of a respective one of said plurality of clusters corresponds to an average of any of said remaining ones of said plurality of overlapping blocks included in said respective one of said plurality of clusters.

6. The apparatus of claim 5, wherein said remaining ones of said plurality of overlapping blocks are downsized prior to said clustering to obtain a plurality of downsized overlapping blocks, said clustering is performed on said plurality of downsized overlapping blocks, and said respective center of said respective one of said plurality of clusters corresponds to said average of any of said plurality of downsized overlapping blocks included in said respective one of said plurality of clusters.

7. The apparatus of claim 1, wherein a signature is respectively created for each of said plurality of high resolution patches included in said second patch library by generating a feature vector there for that includes an average color for a respective one of said plurality of high resolution patches.

8. The apparatus of claim 7, wherein said average color included in said feature vector for said respective one of said plurality of high resolution patches is further of surrounding pixels with respect to said respective one of said plurality of high resolution patches.

9. The apparatus of claim 1, wherein said first patch library includes a plurality of patch clusters, and said pruned version of said picture is generated by dividing said original version of said picture into a plurality of non-overlapping blocks, searching for candidate patch clusters from among said plurality of patch clusters for each of said plurality of non-overlapping blocks based on respective distance metrics from each of said plurality of non-overlapping blocks to respective centers of each of said plurality of patch clusters, identifying a best matching patch from said candidate patch clusters based on one or more criterion, and pruning a corresponding one of said plurality of non-overlapping blocks to obtain a pruned block there for when a difference between said corresponding one of said plurality of non-overlapping blocks and said best matching patch is less than a threshold difference.

10. The apparatus of claim 9, wherein said metadata comprises a patch index for said best matching patch when said difference between said corresponding one of said plurality of non-overlapping blocks and said best matching patch is less than said threshold difference, said metadata further comprising a block identifier for said pruned block.

11. A method, comprising:
creating a first patch library, from an original version of a picture in a video sequence and a second patch library from a reconstructed version of said picture in said video sequence, each of said first patch library and said second patch library including a plurality of high resolution replacement patches for replacing one or more pruned blocks during a recovery of a pruned version of said picture; and
generating said pruned version of said picture from said first patch library;
generating metadata from said second patch library for use in recovering said pruned version of said picture; and
encoding said pruned version of said picture and said metadata.

12. The method of claim 11, wherein said pruned version of said picture is generated by dividing said original version of said picture into a plurality of blocks, and respectively replacing at least one of said plurality of blocks with a replacement patch, wherein all pixels in said replacement patch have one of a same color value or a low resolution.

13. The method of claim 12, wherein said same color value is equal to an average of color values of said pixels within said at least one of said plurality of blocks.

14. The method of claim 11, wherein said first patch library is created by dividing said original version of said picture into a plurality of overlapping blocks to form a training data set, removing any of said plurality of overlapping blocks from said training set having a high frequency component above a pre-specified threshold, and clustering remaining ones of said plurality of overlapping blocks into a plurality of clusters, wherein each of said remaining ones of said plurality of overlapping blocks form a respective one of said plurality of high resolution replacement patches.

15. The method of claim 13, wherein a respective center of a respective one of said plurality of clusters corresponds to an average of any of said remaining ones of said plurality of overlapping blocks included in said respective one of said plurality of clusters.

16. The method of claim 14, wherein said remaining ones of said plurality of overlapping blocks are downsized prior to said clustering to obtain a plurality of downsized overlapping blocks, said clustering is performed on said plurality of downsized overlapping blocks, and said respective center of said respective one of said plurality of clusters corresponds to said average of any of said plurality of downsized overlapping blocks included in said respective one of said plurality of clusters.

17. The method of claim 11, wherein a signature is respectively created for each of said plurality of high resolution patches included in said second patch library by generating a feature vector there for that includes an average color for a respective one of said plurality of high resolution patches.

18. The method of claim 17, wherein said average color included in said feature vector for said respective one of said plurality of high resolution patches is further of surrounding pixels with respect to said respective one of said plurality of high resolution patches.

19. The method of claim 11, wherein said first patch library includes a plurality of patch clusters, and said pruned version of said picture is generated by dividing said original version of said picture into a plurality of non-overlapping blocks, searching for candidate patch clusters from among said plurality of patch clusters for each of said plurality of non-overlapping blocks based on respective distance metrics from each of said plurality of non-overlapping blocks to respective centers of each of said plurality of patch clusters, identifying a best matching patch from said candidate patch clusters based on one or more criterion, and pruning a corresponding one of said plurality of non-overlapping blocks to obtain a pruned block there for when a difference between said corresponding one of said plurality of non-overlapping blocks and said best matching patch is less than a threshold difference.

20. The method of claim 19, wherein said metadata comprises a patch index for said best matching patch when said difference between said corresponding one of said plurality of non-overlapping blocks and said best matching patch is less than said threshold difference, said metadata further including a block identifier for said pruned block.

21. An apparatus, comprising:
means for creating a first patch library from an original version of a picture in a video sequence and a second patch library from a reconstructed version of said picture in said video sequence, each of said first patch library and said second patch library including a plurality of high resolution replacement patches for replacing one or more pruned blocks during a recovery of a pruned version of said picture; and
means for generating said pruned version of said picture from said first patch library;
means for generating metadata from said second patch library for use in recovering said pruned version of said picture; and
means for encoding said pruned version of said picture and said metadata.

22. The apparatus of claim 21, wherein said pruned version of said picture is generated by dividing said original version of said picture into a plurality of blocks, and respectively replacing at least one of said plurality of blocks with a replacement patch, wherein all pixels in said replacement patch have one of a same color value or a low resolution.

23. The apparatus of claim 22, wherein said same color value is equal to an average of color values of said pixels within said at least one of said plurality of blocks.

24. The apparatus of claim 21, wherein said first patch library is created by dividing said original version of said picture into a plurality of overlapping blocks to form a training data set, removing any of said plurality of overlapping blocks from said training set having a high frequency component above a pre-specified threshold, and clustering remaining ones of said plurality of overlapping blocks into a plurality of clusters, wherein each of said remaining ones of said plurality of overlapping blocks form a respective one of said plurality of high resolution replacement patches.

25. The apparatus of claim 24, wherein a respective center of a respective one of said plurality of clusters corresponds to an average of any of said remaining ones of said plurality of overlapping blocks included in said respective one of said plurality of clusters.

26. The apparatus of claim 25, wherein said remaining ones of said plurality of overlapping blocks are downsized prior to said clustering to obtain a plurality of downsized overlapping blocks, said clustering is performed on said plurality of downsized overlapping blocks, and said respective center of said respective one of said plurality of clusters corresponds to said average of any of said plurality of downsized overlapping blocks included in said respective one of said plurality of clusters.

27. The apparatus of claim 21, wherein a signature is respectively created for each of said plurality of high resolution patches included in said second patch library by generating a feature vector there for that includes an average color for a respective one of said plurality of high resolution patches.

28. The apparatus of claim 27, wherein said average color included in said feature vector for said respective one of said plurality of high resolution patches is further of surrounding pixels with respect to said respective one of said plurality of high resolution patches.

29. The apparatus of claim 21, wherein said first patch library includes a plurality of patch clusters, and said pruned version of said picture is generated by dividing said original version of said picture into a plurality of non-overlapping blocks, searching for candidate patch clusters from among said plurality of patch clusters for each of said plurality of non-overlapping blocks based on respective distance metrics from each of said plurality of non-overlapping blocks to respective centers of each of said plurality of patch clusters, identifying a best matching patch from said candidate patch clusters based on one or more criterion, and pruning a corresponding one of said plurality of non-overlapping blocks to obtain a pruned block there for when a difference between said corresponding one of said plurality of non-overlapping blocks and said best matching patch is less than a threshold difference.

30. The apparatus of claim 29, wherein said metadata includes a patch index for said best matching patch when said difference between said corresponding one of said plurality of non-overlapping blocks and said best matching patch is less than said threshold difference, said metadata further including a block identifier for said pruned block.
